(19) United States
(12) Patent Application Publication
(10) Pub. No.: US 2024/0132647 A1
(43) Pub. Date: Apr. 25, 2024

(54) VINYL-ADDITION POLYNORBORNENE CATIONIC COMPOSITIONS AND USES THEREOF IN ANION EXCHANGE MEMBRANE FUEL CELLS AND ELECTROLYZERS

(71) Applicant: UT-Battelle, LLC, Oak Ridge, TN (US)

(72) Inventors: Tomonori Saito, Knoxville, TN (US); Michelle Lehmann, Knoxville, TN (US)

(21) Appl. No.: 18/371,630

(22) Filed: Sep. 22, 2023

Related U.S. Application Data
(60) Provisional application No. 63/426,379, filed on Nov. 18, 2022.
(60) Provisional application No. 63/411,198, filed on Sep. 29, 2022.

(51) Int. Cl. C08F 232/08; C25B 9/23; C25B 13/08; H01M 8/1023

(52) U.S. Cl. CPC C08F 232/08; C25B 9/23; C25B 13/08; H01M 8/1023; C08F 2800/10; H01M 2008/1095

(57) ABSTRACT

A polymeric composition having the following structure:

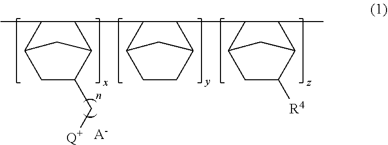

wherein: Q^{±} is a quaternary ammonium group; R⁴ is a hydrocarbon group containing 1-12 carbon atoms and optionally substituted by one or more fluorine atoms; n is an integer of 1-12; x and y are molar amounts independently selected from 0.01-0.99; z is 0 or a molar amount selected from 0.01-0.99; A⁻ is a counteranion; provided that x+y+z=1. Also described herein are anion exchange membrane fuel cells (AEMFCs) and anion exchange membrane water electrolyzers (AEMWEs) containing a polymeric composition within the scope of Formula (1), either in a membrane or as an electrode binder or both.

### CROSS REFERENCE TO RELATED APPLICATION

The present application claims benefit of U.S. Provisional Application No. 63/411,198, filed on Sep. 29, 2022, and U.S. Provisional Application No. 63/426,379, filed on Nov. 18, 2022, all of the contents of which are incorporated herein by reference.

### GOVERNMENT SUPPORT

This invention was made with government support under Prime Contract No. DE-AC05-00OR22725 awarded by the U.S. Department of Energy. The government has certain rights in the invention.

### FIELD OF THE INVENTION

The present invention generally relates to cationic polymeric compositions useful as membranes or ionomers in anion exchange membrane fuel cells (AEMFCs) and anion exchange membrane water electrolyzers (AEMWEs). The present invention is more particularly directed to such cationic polymeric compositions having a polynorbornene copolymer composition and their use in AEMFCs and AEMWEs.

### BACKGROUND

Anion exchange membranes (AEM) are a key component for a variety of technologies including fuel cells, electrolyzers and redox flow batteries. Anion exchange membrane fuel cells (AEMFC) are of interest as a relatively inexpensive alternative to the traditional proton exchange membrane fuel cell. Use of an alkaline electrolyte permits incorporation of a wider range of stable, low-cost materials and components, including platinum-free catalysts and inexpensive corrosion resistant bipolar plates. Similarly, anion exchange (alkaline) electrolyzers (i.e., AEMWEs) are an attractive technology for producing low-cost hydrogen and utilize similar materials as AEMFCs.

Anion exchange polymers can be used in membranes of an AEMFC (or electrolyzer) or in ionomers that function as binders for the catalyst layer. Ionomers are mixed with electrode particles to make an ink, then sprayed onto a membrane surface and allowed to dry. A number of anion exchange polymers contain an aromatic backbone, but these are prone to phenyl oxidation, which results in degradation of the membrane or ionomer binder. These and other types of anion exchange polymers known in the art may have any one or more other substantial drawbacks, such as an unacceptably high water uptake, insufficient hydroxide conductivity, insufficient mechanical strength in the wet state, or insufficient conductivity. Moreover, while there have been efforts to employ crosslinking to control swelling and water uptake, crosslinking tends to render the polymer insoluble, which prevents its use as a soluble ionomer. For the advancement of AEMFC and electrolyzer technologies, improved high performance anion exchange polymers are needed to overcome the above noted issues and which also provide improved area specific resistance (ASR) over the long term (e.g., greater than 1,000 hours) at high temperatures (80° C.) and low-cost, scalable, and solution processable ionomers allowing for wide operation windows (low and high current density operation).

### SUMMARY

In one aspect, the present disclosure is directed to anion exchange polymeric compositions containing a polynorbornene copolymer structure in which one portion of the norbornene units are derivatized with a quaternary ammonium group and another portion of the norbornene units are underivatized. The copolymer may or may not include an additional portion of norbornene units derivatized with a hydrocarbon group (or more particularly, linear or branched alkyl group) containing 1-12 carbon atoms optionally substituted by one or more fluorine atoms. The anion exchange polymer compositions described herein advantageously possess a low water uptake, high hydroxide conductivity, sufficient to superior mechanical strength in a wet state, and sufficient to superior conductivity. Moreover, the anion exchange polymer compositions described herein can achieve these abilities without being crosslinked.

The anion exchange polymeric compositions described herein may more particularly have the following structure:

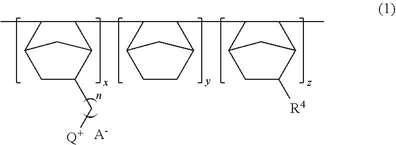

wherein: Q⁺ is a quaternary ammonium group; R⁴ is a hydrocarbon group (or more particularly, a linear or branched alkyl group) containing 1-12 carbon atoms and optionally substituted by one or more fluorine atoms; n is an integer of 1-12 (or more particularly 1-6); x and y are molar amounts independently selected from 0.01-0.99 (or more particularly, 0.1-0.9 or 0.2-0.8); z is 0 or a molar amount selected from 0.01-0.99 (or more particularly, 0.1-0.9 or 0.2-0.8); A⁻ is a counteranion; provided that x+y+z=1. In some embodiments, the polymeric composition of Formula (1) is uncrosslinked. In further or separate embodiments, the polymeric composition of Formula (1) is a random copolymer or a block copolymer.

In more particular embodiments, the anion exchange polymeric compositions described herein have the following structure:

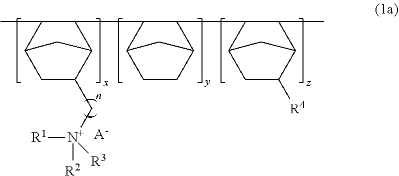

wherein: R¹, R², and R³ are independently selected from hydrocarbon groups (or more particularly, a linear or branched alkyl group) containing 1-6 carbon atoms, wherein RR¹ and R² optionally interconnect to form a cyclic nitrogen-containing ring; R⁴ is a hydrocarbon group (or more particularly, a linear or branched alkyl group) containing 1-12 carbon atoms and optionally substituted by one or more fluorine atoms; n is an integer of 1-12 (or more particularly 1-6); x and y are molar amounts independently selected from 0.01-0.99 (or more particularly, 0.1-0.9 or 0.2-0.8); z is 0 or a molar amount selected from 0.01-0.99 (or more particularly, 0.1-0.9 or 0.2-0.8); A⁻ is a counteranion; provided that x+y+z=1. In some embodiments, the polymeric composition of Formula (1a) is uncrosslinked. In further or separate embodiments, the polymeric composition of Formula (1a) is a random copolymer or a block copolymer.

In another aspect, the present disclosure is directed to an anion exchange membrane fuel cell (AEMFC) containing: a) an anode comprising anode particles dispersed in a first binder; (b) a cathode comprising cathode particles dispersed in a second binder; and (c) an anion exchange membrane in contact with the anode and cathode; wherein at least one of the first binder, second binder, and anion exchange membrane has a polymeric composition corresponding to any of the anion exchange polymeric compositions described above. In some embodiments, the polymeric composition in the AEMFC is uncrosslinked. In further or separate embodiments, the polymeric composition in the AEMFC is a random copolymer or a block copolymer.

In another aspect, the present disclosure is directed to an anion exchange membrane water electrolyzer (AEMWE) containing: a) an anode comprising anode particles dispersed in a first binder; (b) a cathode comprising cathode particles dispersed in a second binder; and (c) an anion exchange membrane in contact with the anode and cathode; wherein at least one of the first binder, second binder, and anion exchange membrane has a polymeric composition corresponding to any of the anion exchange polymeric compositions described above. In some embodiments, the polymeric composition in the AEMWE is uncrosslinked. In further or separate embodiments, the polymeric composition in the AEMWE is a random copolymer or a block copolymer.

### BRIEF DESCRIPTION OF THE DRAWINGS

FIGS. 1a-1b. FIG. 1a is a scheme showing an exemplary synthesis of a series of bromoalkyl- and alkyl-derivatized norbornene molecules. FIG. 1b is a scheme showing an exemplary polymerization reaction of the bromoalkyl- and alkyl-derivatized norbornene molecules and subsequent amination to produce polynorbornene copolymers useful as anion exchange membranes. In the copolymers, the alkyl chain length was varied, n=1, 3, and 6, to yield quaternized polymers QMN, QPN, and QHN. In the terpolymers shown in FIG. 1b, the molar ratio of x (hexyl norbornene) was varied to yield quaternized polymers QP-HN6, QP-HN15, and QP-HN30.

FIGS. 2a-2c. FIG. 2a is a graph plotting water uptake, swelling ratio, and hydration number of polynorbornene membranes, measured in water at room temperature in OH⁻ form. FIG. 2b is a graph plotting OH⁻ conductivity of membranes in water. Error bars are the standard deviation of at least 3 samples. FIG. 2c is a graph plotting IEC normalized conductivity of the polynorbornene membranes.

FIG. 3 is a graph showing SANS profiles of the QHN and QPN polynorbornene membranes in OH⁻ as either dry or soaked in D₂O.

FIGS. 4a-4b. FIG. 4a is a graph plotting storage (E′) and loss (E″) moduli of dry polynorbornene membranes in OH⁻ form. FIG. 4b is a graph showing representative stress—strain curves of membranes in OH⁻ form.

FIG. 5 is a graph plotting alkaline stability of polynorbornene AEMs after soaking in 1 M NaOH at 80° C., conductivity of QPN and QHN at 25° C., and IEC of QPN membranes.

FIGS. 6a-6b. FIG. 6a is a graph comparing AEMFC membrane performance. QPN membrane (thickness=30 μm). XL-SEBS membrane (thickness=60 μm). Ionomer for both MEAs: poly(fluorene)-based. Both cells operated at 80° C. under high stoics. Back pressure: 285 kPa_{abs}. FIG. 6b is a graph comparing AEMFC ionomer performance. Both cells used identical catalysts and loadings (anode: PtRu/C 0.5 mg_{Pt} cm⁻², cathode: Pt/C 0.6 0.5 mg_{Pt} cm⁻²) and tests were conducted at 80° C. in H₂/O₂, flowrates of 1400 (H₂)/700 (O₂) sccm and 147 kPa backpressure. The QP-HN20 cell operated at 100% RH. The FLN cell operated at 100% RH for the anode (FLN-55) and 50% RH for the cathode (FLN-100). The left graphs in FIGS. 6a-6b show fuel cell power density and voltage with applied current density. The right graphs show cell high frequency resistance with applied current density.

### DETAILED DESCRIPTION

As used herein, the term “hydrocarbon group” (also denoted by the group R) is defined as a chemical group containing at least carbon and hydrogen atoms. In some embodiments, R is composed of solely carbon and hydrogen. In other embodiments, R is composed of carbon and hydrogen with optional substitution of the hydrocarbon group with one or more fluorine atoms to result in partial or complete fluorination of the hydrocarbon group. In different embodiments, one or more of the hydrocarbon groups contain, for example, 1, 2, 3, 4, 5, 6, 7, 8, 9, 10, 11, or 12 carbon atoms, or a number of carbon atoms within a particular range bounded by any two of the foregoing carbon numbers (e.g., 1-12, 1-8, 1-6, 1-5, 1-4, 1-3, 2-12, 2-8, 2-6, 2-5, 2-4, or 2-3 carbon atoms). Hydrocarbon groups in different compounds described herein, or in different generic groups of a compound, may possess the same or different number (or preferred range thereof) of carbon atoms. For example, any one of R¹, R², R³, and/or R⁴ in any of the generic formulas disclosed herein may independently contain a number of carbon atoms within any of the ranges provided above.

In a first set of embodiments, the hydrocarbon group (R) is a saturated and straight-chained group, i.e., a straight-chained (linear) alkyl group. Some examples of straight-chained alkyl groups include methyl, ethyl, n-propyl, n-butyl, n-pentyl, n-hexyl, n-heptyl, n-octyl, n-nonyl, n-decyl, n-undecyl, and n-dodecyl groups.

In a second set of embodiments, the hydrocarbon group (R) is saturated and branched, i.e., a branched alkyl group. Some examples of branched alkyl groups include isopropyl (2-propyl), isobutyl (2-methylprop-1-yl), sec-butyl (2-butyl), t-butyl (1,1-dimethylethyl-1-yl), 2-pentyl, 3-pentyl, 2-methylbut-1-yl, isopentyl (3-methylbut-1-yl), 1,2-dimethylprop-1-yl, 1,1-dimethylprop-1-yl, neopentyl (2,2-dimethylprop-1-yl), 2-hexyl, 3-hexyl, 2-methylpent-1-yl, 3-methylpent-1-yl, isohexyl (4-methylpent-1-yl), 1,1-dimethylbut-1-yl, 1,2-dimethylbut-1-yl, 2,2-dimethylbut-1-yl, 2,3-dimethylbut-1-yl, 3,3-dimethylbut-2-yl, 1,1,2-trimethylprop-1-yl, 1,2,2-trimethylprop-1-yl groups, isoheptyl, isooctyl, and the numerous other branched alkyl groups having up to 12 carbon atoms, wherein the “1-yl” suffix represents the point of attachment of the group.

In a third set of embodiments, the hydrocarbon group (R) is saturated and cyclic, i.e., a cycloalkyl group. Some examples of cycloalkyl groups include cyclopropyl, cyclobutyl, cyclopentyl, cyclohexyl, cycloheptyl, and cyclooctyl groups. The cycloalkyl group can also be a polycyclic (e.g., bicyclic) group by either possessing a bond between two ring groups (e.g., dicyclohexyl) or a shared (i.e., fused) side (e.g., decalin and norbornane).

In a fourth set of embodiments, the hydrocarbon group (R) is unsaturated and straight-chained, i.e., a straight-chained (linear) olefinic or alkenyl group. The unsaturation occurs by the presence of one or more carbon-carbon double bonds and/or one or more carbon-carbon triple bonds. Some examples of straight-chained olefinic groups include vinyl, propen-1-yl (allyl), 3-buten-1-yl (CH₂═CH—CH₂—CH₂—), 2-buten-1-yl (CH₂—CH═CH—CH₂—), butadienyl, 4-penten-1-yl, 3-penten-1-yl, 2-penten-1-yl, 2,4-pentadien-1-yl, 5-hexen-1-yl, 4-hexen-1-yl, 3-hexen-1-yl, 3,5-hexadien-1-yl, 1,3,5-hexatrien-1-yl, 6-hepten-1-yl, ethynyl, propargyl (2-propynyl), 3-butynyl, and the numerous other straight-chained alkenyl or alkynyl groups having up to 12 carbon atoms.

In a fifth set of embodiments, the hydrocarbon group (R) is unsaturated and branched, i.e., a branched olefinic or alkenyl group. Some examples of branched olefinic groups include propen-2-yl (CH_{2═}C.—CH₃), 1-buten-2-yl (CH₂═C.—CH₂—CH₃), 1-buten-3-yl (CH₂═CH—CH·—CH3), 1-propen-2-methyl-3-yl (CH₂═C(CH₃)—CH₂—), 1-penten-4-yl, 1-penten-3-yl, 1-penten-2-yl, 2-penten-2-yl, 2-penten-3-yl, 2-penten-4-yl, and 1,4-pentadien-3-yl, and the numerous other branched alkenyl groups having up to 12 carbon atoms, wherein the dot in any of the foregoing groups indicates a point of attachment.

In a sixth set of embodiments, the hydrocarbon group (R) is unsaturated and cyclic, i.e., a cycloalkenyl group. The unsaturated cyclic group can be aromatic or aliphatic. Some examples of unsaturated cyclic hydrocarbon groups include cyclopropenyl, cyclobutenyl, cyclopentenyl, cyclopentadienyl, cyclohexenyl, cyclohexadienyl, phenyl, benzyl, cycloheptenyl, cycloheptadienyl, cyclooctenyl, cyclooctadienyl, and cyclooctatetraenyl groups. The unsaturated cyclic hydrocarbon group may or may not also be a polycyclic group (such as a bicyclic or tricyclic polyaromatic group) by either possessing a bond between two of the ring groups (e.g., biphenyl) or a shared (i.e., fused) side, as in naphthalene, anthracene, phenanthrene, phenalene, or indene fused ring systems. All of the foregoing cyclic groups are carbocyclic groups.

In one aspect, the present disclosure is directed to anion exchange copolymeric compositions having the following structure:

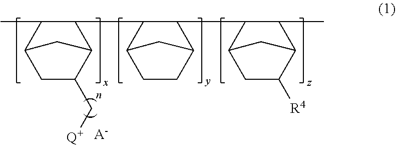

The variable Q⁺ in Formula (1) is a quaternary ammonium group. The quaternary ammonium group can be any group having a positively charged nitrogen atom (N⁺) attached to the linker (—(CH₂)ₙ)—) shown in Formula (1) along with three hydrocarbon groups selected from any of the hydrocarbon groups (R) described above. In some embodiments, the N⁺ atom is attached to the shown linker (—(CH₂)ₙ)—) along with three hydrocarbon groups which are not interconnected. In other embodiments, the N⁺ atom is attached to the shown linker along with three hydrocarbon groups, at least two of which are interconnected to form an ammonium-containing ring. When an ammonium-containing ring is present in Q⁺, the ammonium-containing ring may be attached to the shown linker by the N⁺atom or a ring carbon atom of the ammonium-containing ring.

The variable R⁴ in Formula (1) is a hydrocarbon group (R), as described above, containing 1-12 carbon atoms and optionally substituted by one or more fluorine atoms. In some embodiments, R⁴ is composed of only carbon and hydrogen atoms. In other embodiments, R⁴ is a partially or fully fluorinated hydrocarbon group. In different embodiments, R⁴ contains 1, 2, 3, 4, 5, 6, 7, 8, 9, 10, 11, or 12 carbon atoms, or a number of carbon atoms within a range bounded by any two of the foregoing numbers, e.g., 1-10, 1-8, 1-6, 1-4, 1-3, 2-12, 2-10, 2-8, 2-6, 2-4, 3-12, 3-10, 3-8, 3-6, 4-12, 4-10, or 4-8 carbon atoms. In some embodiments, R⁴ is a linear or branched alkyl or alkenyl group containing 1-12 carbon atoms, such as any of those described above for R.

The variable n in Formula (1) is an integer of 1-12. In different embodiments, n is an integer of 1, 2, 3, 4, 5, 6, 7, 8, 9, 10, 11, or 12, or a number of within a range bounded by any two of the foregoing numbers, e.g., 1-10, 1-8, 1-6, 1-4, 1-3, 2-12, 2-10, 2-8, 2-6, 2-4, 3-12, 3-10, 3-8, 3-6, 4-12, 4-10, and 4-8.

The variables x and y in Formula (1) are molar amounts independently selected from a value within the range of 0.01-0.99. The variable z in Formula (1) is 0 or a molar amount selected from a value within the range of 0.01-0.99. In different embodiments, the variables x and y (and optionally z, when z is not 0) are independently selected from 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 0.99, or each of x and y (and optionally z) may independently be within a range bounded by any two of the foregoing values, e.g., 0.01-0.9, 0.01-0.8, 0.01-0.7, 0.01-0.6, 0.01-0.5, 0.01-0.4, 0.01-0.3, 0.01-0.2, 0.01-0.1, 0.1-0.99, 0.1-0.9, 0.1-0.8, 0.1-0.7, 0.1-0.6, 0.1-0.5, 0.1-0.4, 0.1-0.3, 0.1-0.2, 0.2-0.99, 0.2-0.9, 0.2-0.8, 0.2-0.7, 0.2-0.6, 0.2-0.5, 0.2-0.4, 0.3-0.99, 0.3-0.9, 0.3-0.8, 0.3-0.7, 0.3-0.6, 0.3-0.5, 0.4-0.99, 0.4-0.9, 0.4-0.8, 0.4-0.7, 0.4-0.6, 0.5-0.99, 0.5-0.9, 0.5-0.8, 0.5-0.7, 0.6-0.99, 0.6-0.9, 0.6-0.8, 0.7-0.99, 0.7-0.9, and 0.8-0.99, provided that x+y+z=1. In some embodiments, z is 0. When z is 0, x +y =1. In some embodiments, x and y are molar amounts independently selected from 0.1-0.9, and z is 0 or a molar amount selected from 0.1-0.9, provided that x+y+z=1. In other embodiments, x and y are molar amounts independently selected from 0.2-0.8, z is 0 or a molar amount selected from 0.2-0.8, provided that x+y+z=1. In other embodiments, x, y, and z are molar amounts independently selected from 0.01-0.99; provided that x+y+z=1. In other embodiments, x, y, and z are molar amounts independently selected from 0.1-0.9; provided that x+y+z=1. In other embodiments, x, y, and z are molar amounts independently selected from 0.2-0.8; provided that x+y+z=1. In some embodiments, y is at least or greater than 0.1, 0.2, 0.3, 0.4, or 0.5 and may have a maximum selected from any of the values provided earlier above.

The variable A⁻ in Formula (1) is a counteranion to charge balance Q⁺. A⁻ may be any of the anions known in the art. A⁻ may be, for example, hydroxide, a halide (e.g., chloride, bromide, iodide, or triodide), sulfonate, carboxylate (e.g., acetate or formate), trifluoroborate, dicyanamide, tricyanomethanide, trifluoromethanesulfonimide, bis-(malonato)borate, fluoromalonatoborate, fluoroalkylsulfonamide, fluoralkylsulfonate, or fluorosulfonimide (FSO₂N⁽⁻⁾SO₂—).

In more particular embodiments of Formula (1), the anion exchange copolymer has the following structure:

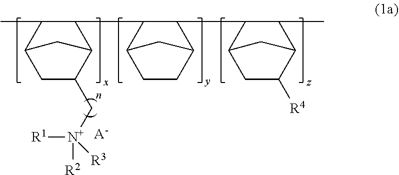

In Formula (1a), Q⁺ of Formula (1) is more specifically N⁺R¹R²R³. The variables R⁴, n, x, y, z, and A⁻ in Formula (1a) are as described above under Formula (1), including any of the examples and possible ranges provided under Formula (1). The variables R¹, R², and R³ are independently selected from hydrocarbon groups (R) containing 1-6 carbon atoms, as described above. In some embodiments, R¹, R², and R³ are composed of only carbon and hydrogen atoms. In different embodiments, R¹, R², and R³ independently contain 1, 2, 3, 4, 5, or 6 carbon atoms, or a number of carbon atoms within a range bounded by any two of the foregoing numbers, e.g., 1-6, 1-4, 1-3, 1-2, 2-6, 2-4, 3-6, 3-5, and 4-6. In some embodiments, R¹, R¹, and R¹ are independently selected from linear or branched alkyl or alkenyl groups containing 1-6 carbon atoms, such as any of those described above for R. In some embodiments, precisely or at least one, two, or all of R¹, R¹, and R¹ is/are methyl groups. In some embodiments, two or three of R¹, R¹, and R¹ interconnect to form an ammonium ring or ring system. In some embodiments, R¹ and R¹ interconnect to form an ammonium ring, while R¹ is selected from any of the hydrocarbon groups (R) containing 1-6 carbon atoms, as described above. In other embodiments, none of R¹, R¹, and R¹ are interconnected.

The copolymeric composition described above for Formula (1) or Formula (1a) can have any of the copolymer arrangements known in the art, including block, random, alternating, and brush arrangements. In the case of a block arrangement, the block copolymer may have a diblock structure (when z is 0) or a triblock structure (when z is not 0). One or more additional blocks to result in, e.g., a tetrablock or higher copolymer, may or may not be included. The copolymeric composition described above for Formula (1) or Formula (1a) may also be crosslinked or uncrosslinked.

In another aspect, the present invention is directed to an anion exchange membrane containing any of the anion exchange polymeric compositions described above. The membrane is typically in the shape of a film. The membrane typically has a thickness of no more than or less than 200 microns. In different embodiments, the membrane has a thickness of about, up to, or less than, for example, 0.5, 1, 5, 10, 20, 25, 30, 40, 50, 60, 70, 80, 90, 100, 120, 150, 180, or 200 microns or a thickness within a range bounded by any two of the foregoing values (e.g., 0.5-200, microns, 0.5-100 microns, 0.5-50 microns, 0.5-30 microns, 0.5-25 microns, 0.5-20 microns, 1-50 microns, 1-30 microns, 1-25 microns, or 1-20 microns). In some embodiments, the membrane is substantially uniform, such as by having a roughness of less than a micron or so.

The polymeric composition or membrane thereof described above may have exceptional mechanical properties, which may be evidenced by, for example, an exceptional Young's modulus, tensile strength, elongation at break, and/or storage modulus. The polymeric composition or membrane thereof may have a Young's modulus of at least, for example, 300, 325, 350, 375, 400, 425, 450, 475, or 500 MPa at 25° C. The polymeric composition or membrane thereof may have a tensile strength of at least, for example, 12, 14, 16, 18, or 20 MPa at 25° C. The polymeric composition or membrane thereof may have an elongation at break of precisely or at least, for example, 2, 5, 10, 15, 20, 25, 30, 40, 45, 50, 55, 60, 70, 80, 90, or 100%, or an elongation within a range bounded by any two of the foregoing values. The polymeric composition or membrane thereof may have a storage modulus of precisely or at least, for example, 200, 300, 400, 500, 1000, 1500, 2000, or 2500 MPa, or a storage modulus within a range bounded by any two of the foregoing values.

The polymeric composition or membrane thereof described above typically has a conductivity of at least or above 1.0×10⁻⁶ S/cm at 25° C. or 30° C. In different embodiments, the polymeric composition or membrane has a conductivity of at least or above 1.0×10⁻⁶ S/cm, 2.0×10⁻⁶ S/cm, 3.0×10⁻⁶ S/cm, 4.0×10⁻⁵ S/cm, 5.0×10⁻⁶ S/cm, 6.0×10⁻⁶ S/cm, 7.0×10^{∓6} S/cm, 8.0×10⁻⁶ S/cm, 9.0×10⁻⁶ S/cm, 1.0×10⁻⁵ S/cm, 2.0×10⁻⁵ S/cm, 3.0×10⁻⁵ S/cm, 4.0×10⁻⁵ S/cm, 5.0×10⁻⁵ S/cm, 6.0×10⁻⁵ S/cm, 7.0×10⁻⁵ S/cm, 8.0×10⁵ S/cm, 9.0 ×10⁻⁵ S/cm, or 1.0×10⁻S/cm at 25° C. or 30° C.

In another aspect, the present disclosure is directed to a method for producing the polymeric compositions described above. Typically, a bromoalkylnorbornene and norbornene (underivatized), and optionally, a hydrocarbylnorbornene, are dissolved in an organic solvent and contacted with an appropriate vinyl addition polymerization catalyst (e.g., trans-[Ni(C₆F₅)2(SbPh₃)₂]) to result in a precursor polymer containing norbornene units functionalized with bromoalkyl groups. The precursor polymer is then reacted with an amine molecule to replace the bromine atom with the amine molecule to form the corresponding ammonium group. In some embodiments, the precursor polymer is first cast onto a surface and dried to form a solid (or gel) membrane before the precursor polymer is reacted with the amine molecule. In alternative embodiments, the bromalkylnorbornene may first be reacted with an amine to convert it to an amine, followed by co-polymerization.

In another aspect, the present disclosure is directed to anion exchange membrane fuel cells (AEMFCs) containing: a) an anode (negatively charged electrode) containing anode particles dispersed in a first binder (i.e., first ionomer); (b) a cathode (positively charged electrode) containing cathode particles dispersed in a second binder (i.e., second ionomer); and (c) an anion exchange membrane in contact with the anode and cathode. For purposes of the invention, at least one of the first binder, second binder, and anion exchange membrane has any of the anion exchange polymeric compositions described above, such as any of the compositions within the scope of Formula (1) or (1a) in this application. In a first set of embodiments, the anode contains anode particles dispersed in an anion exchange polymeric composition described herein, while the cathode and/or the anion exchange membrane may or may not contain an anion exchange polymeric composition described herein. In a second set of embodiments, the cathode contains cathode particles dispersed in an anion exchange polymeric composition described herein, while the anode and/or the anion exchange membrane may or may not contain an anion exchange polymeric composition described herein. In a third set of embodiments, the anion exchange membrane contains an anion exchange polymeric composition described herein, while the anode and/or the cathode may or may not contain an anion exchange polymeric composition described herein.

As AEMFCs are well known in the art, the various types of anodes, cathodes, and their other components and mode of operation are also well known. Reference is made to, for example, M. Hren et al., Sustainable Energy Fuels, 5, 604, 2021, which is incorporated herein by reference. As well known, the anode and cathode particles in AEMFCs are electrochemical oxidation and reduction catalysts, respectively. Hydroxide (OH⁻) ion is generated by reduction of water at the cathode and transported across the anion exchange membrane to the anode where a fuel (e.g., hydrogen, methanol, or ethanol) in contact with the anode is electrocatalytically oxidized and forms water upon combination with the hydroxide ions. In typical embodiments, the anode particles have a Pt, Pt alloy, or metal-Pt core-shell composition (e.g., Ru/Pt and Au/Pt). In typical embodiments, the cathode particles have a Pt or Pd composition, or Pt—Pd alloy composition, or a Pt-metal alloy or Pd-metal alloy composition in which the metal is, for example, Ru, Sn, Au, Ni, Ag, Cu, or Co. In typical embodiments, the anode and cathode active material is overlaid with a gas diffusion layer, such as a porous carbon layer.

In another aspect, the present disclosure is directed to anion exchange membrane water electrolyzers (AEMWEs) containing: a) an anode (negatively charged electrode) containing anode particles dispersed in a first binder (i.e., first ionomer); (b) a cathode (positively charged electrode) containing cathode particles dispersed in a second binder (i.e., second ionomer); and (c) an anion exchange membrane in contact with the anode and cathode. For purposes of the invention, at least one of the first binder, second binder, and anion exchange membrane has any of the anion exchange polymeric compositions described above, such as any of the compositions within the scope of Formula (1) or (1a) in this application. In a first set of embodiments, the anode contains anode particles dispersed in an anion exchange polymeric composition described herein, while the cathode and/or the anion exchange membrane may or may not contain an anion exchange polymeric composition described herein. In a second set of embodiments, the cathode contains cathode particles dispersed in an anion exchange polymeric composition described herein, while the anode and/or the anion exchange membrane may or may not contain an anion exchange polymeric composition described herein. In a third set of embodiments, the anion exchange membrane contains an anion exchange polymeric composition described herein, while the anode and/or the cathode may or may not contain an anion exchange polymeric composition described herein.

As AEMWEs are well known in the art, the various types of anodes, cathodes, and their other components and mode of operation are also well known. Reference is made to, for example, N. Du et al., Chem. Rev., 122, 11830-11895, 2022, which is incorporated herein by reference. As well known, the anode and cathode particles in AEMWEs are electrochemical oxidation and reduction catalysts, respectively. Water travels from the anode through the membrane while hydrogen is produced at the cathode. Hydroxide ion supplied at the cathode is transported through the membrane and is converted to oxygen at the anode. The result is the evolution of oxygen at the anode and hydrogen at the cathode. In some embodiments, a KOH solution is made to be in contact with the anode, which wets the membrane, while the cathode side remains dry. In typical embodiments, the anode and cathode particles have transition metal (although non-noble metal) compositions, such as those based on Ni, Fe, Cu, and Co. In typical embodiments, the anode and cathode active material is overlaid with a gas diffusion layer, such as a porous carbon layer.

Examples have been set forth below for the purpose of illustration and to describe certain specific embodiments of the invention. However, the scope of this invention is not to be in any way limited by the examples set forth herein.

### EXAMPLES

### Overview

The anion exchange membrane (AEM) properties for a series of polynorbornene random copolymers were investigated. In particular, the role of the quaternary ammonium tether length and the impact of unsubstituted norbornene on membrane properties such as water uptake and conductivity were elucidated. The facile synthesis of random copolymers to high molecular weights permits robust mechanical properties of the resulting membranes along with a potential scale-up path. Furthermore, membrane properties were specifically tailored by varying the ratio of unsubstituted norbornene and norbornene derivatives within the polymers. Furthermore, the performance of the quaternized polynorbornene random copolymers were demonstrated in an AEMFC.

### Small Molecule Synthesis

Synthesis of 5-bromomethyl-2-norbornene (BMN). The synthesis of bromomethyl norbornene was carried out following a literature procedure.(M. A. Higgins et al., J Pol Sci, 18 (58), 2644-2653, 2020). Allyl bromide (21.0 g, 173.6 mmol), dicyclopentadiene (11.5 g, 86.8 mmol), and hydroquinone (0.1 g) were added to a 150 ml pressure vessel and heated at 180° C. for 15 h. The product was purified by sequential distillations (4 torr, 100° C.) to yield 14.0 g of product (45% yield). Endo. ¹H NMR (400 Hz, CDCl₃) δ (ppm): 6.23 (dd, 1H), 6.03 (dd, 1H), 3.24 (dd, 1H), 3.06 (br, 2H,), 2.90 (br s, 1H), 2.55 (m, 1H), 1.98 (m, 1H), 1.51 (m, 1H), 1.32 (d, 1H), 0.62 (ddd, 1H). Exo: 6.12 (m, 2H), 3.46 (m, 1H), 2.81 (br s, 1H).

Synthesis of 5-(3-bromopropyl)-2-norbornene (BPN). The synthesis was similar to a literature procedure (S. Martinez-Arranz et al., Macromolecules, 18 (43), 7482-7487, 2010). Dicyclopentadiene (11.09 g, 83.9 mmol), 5-bromopentene (37.5 g, 251.6 mmol), and hydroquinone (0.4 g) were added to a 150 ml pressure vessel, then heated at 200° C. for 72 h. The product was purified by sequential distillations (1.5 torr, 120° C.) to yield 13.1 g of product (36% yield). Endo. ¹H NMR (400 Hz, CDCl₃) δ (ppm): 6.16 (dd, 1H), 5.94 (dd, 1H), 3.41 (t, 2H), 2.79 (br, 2H), 2.02 (m, 1H), 1.87 (m, 3H), 1.41 (m, 1H), 1.25 (m, 3H), 0.47 (ddd, 1H). Exo: 6.10 (dd, 1H), 6.05 (dd, 1H), 2.54 (br s, 1H).

Synthesis of 5-(6-bromohexyl)-2-norbornene (BHN). Dicyclopentadiene (13.0 g, 98.1 mmol) and 8-bromooctene (37.5 g, 196.2 mmol) were added to a 150 ml pressure vessel, then heated at 210° C. for 72 h. The product was purified by distillation under reduced pressure (2.0 torr, 170° C.), then column chromatography (CombiFlash) using 4:1 hexanes/ethyl acetate to yield 11.5 g of product (11% yield). Endo. ¹H NMR (400 Hz, CDCl₃) δ (ppm): 6.12 (dd, 1H), 5.93 (dd, 1H), 3.43 (t, 2H), 2.77 (br, 2H), 1.98 (m, 1H), 1.86 (m, 3H), 1.37 (br m, 8H), 1.09 (br m, 2H), 0.5 (ddd, 1H). Exo: 6.09 (dd, 1H), 6.02 (dd, 1H), 2.52 (br s, 1H).

Synthesis of 5-n-hexyl-2-norbornene (HN). The synthesis was similar to a literature procedure (F. Pierre et al., Polymer, (86), 91-97, 2016). Dicyclopentadiene (15.0 g, 113.5 mmol) and 1-octene (38.2 g, 340.5 mmol) were added to a 150 ml pressure vessel, then heated at 200° C. for 48 h. The product was purified by sequential distillations (1.85 ton, 110° C.) to yield 14.0 g of product (32% yield). Endo. ¹H NMR (400 Hz, CDCl₃) δ (ppm): 6.13 (dd, 1H), 5.94 (dd, 1H), 2.79 (br s, 2H), 2.00 (m, 1H), 1.85 (m, 1H), 1.31 (br m, 9H), 1.08 (br m, 3H′), 0.91 (br t, 3H) 0.51 (ddd, 1H). Exo: 6.04 (dd, 2H), 2.52 (br s, 1H).

### Polymer Synthesis.

All polymerizations were carried out in an Ar-filled glovebox using a similar procedure, with the ratio of monomers in the feed solution adjusted to obtain the desired polymer composition. The synthesis of BPN was performed as a representative polymerization. The catalyst trans-[Ni(C₆F₅)₂(SbPh₃)₂] (36.8 mg, 0.033 mmol) and 12 ml DCM were added to a dry 100 ml round bottom flask. A solution of BPN (0.554 g, 2.57 mmol) and norbornene (0.699 g, 7.42 mmol) in 3 ml DCM was then injected into the catalyst solution. The reaction mixture was stirred for 15 min, diluted with chloroform, and precipitated into methanol to yield 1.20 g of polymer (95% yield).

Membranes were cast onto a glass plate from a 4 wt % chloroform solution using an adjustable doctor blade, dried, and placed under vacuum to remove any residual solvent. Membranes were released from the glass plate by immersion in water, to obtain free- standing membranes with a thickness of approx. 30 μm. Membranes were then immersed in a 45 wt % aqueous trimethylamine solution for 48 h at room temperature. The ionic membranes were then washed with deionized water (DI) and stored under ambient conditions until use. Polymers in ionic form are denoted as QXN, where X is the trimethylammonium tether length (i.e., poly(trimethylammonium propylnorbornene-r-norbornene, QPN). Polymers containing the hydrophobic HN monomer are denoted as HNX, where X is the molar ratio of HN in the terpolymer (i.e., poly(trimethylammonium propylnorbornene-r-hexylnorbornene-r-norbornene, QP-HN6). The quaternized polynorbornene ionomer for fuel cell testing was prepared using a QP-HN20 ionomer (IEC =2.5 meq/g). The ionomer was converted to hydroxide form by first soaking in deionized water, then excess 1 M NaOH before being rinsed with N₂ purged deionized water. The ionomer was dried under vacuum at room temperature for 48 hours.

### Characterizations

Nuclear magnetic resonance (NMR) analysis was performed using a Bruker Avance III 400 Hz spectrometer. ¹H NMR spectra of the monomers and brominated polymers were collected in chloroform-d. Molecular weights of the brominated polynorbornenes were determined using size exclusion chromatography (SEC) with trichlorobenzene as the eluant at 150° C. against polystyrene standards. Before any characterizations of the membranes were performed in hydroxide form, membranes were hydrated, soaked in an excess of NaOH overnight, and rinsed with nitrogen-purged deionized water to limit carbonate formation. The storage moduli of the membranes in OH⁻ from were determined by dynamic mechanical analysis (DMA) at an operating frequency of 1 Hz and an amplitude of 10 μm.

For dry measurements, samples were heated from 16° C. to 130° C. at a rate of 3° C./min under nitrogen. DMA measurements were performed under a nitrogen atmosphere to limit carbonate formation. A certain amount of carbonation may occur within the membranes but is not expected to significantly influence the thermal properties of the membranes in a dry state. The storage moduli of the membranes were also measured in Cl⁻ form at 80% relative humidity (RH) at a heating rate of 2° C. from 25 80° C. For tensile measurements, the membranes in OH⁻ form were elongated at a rate of 30 mm/min under ambient conditions until break using a universal tensile meter. Reported tensile properties are an average of at least 3 samples.

The ion exchange capacity (IEC) of the ionic membranes was determined using acid-base titration. A piece of membrane in OH⁻ form was placed in 24 ml of 0.01 N HCl for 24 h. The HCl solution was then decanted, and the membrane was rinsed with deionized water to extract all the HCl from the membrane. The solution was then titrated to pH 7 using a standardized 0.005 N NaOH solution and phenolphthalein indicator. The membrane in Cl⁻ form was dried under vacuum at 60° C. for 24 h to obtain the dry mass of the membrane. The IEC was calculated using the following equation:

$$IEC = \frac{{V}_{HCl} {C}_{HCl} - {V}_{NaOH} {C}_{NaOH}}{{M}_{d}} \qquad ( 1 )$$

wherein V is the volume of HCl and NaOH, C is the concentration of HCl and NaOH utilized, and M_{d} is the dry mass of the membrane.

The room temperature water uptake (WU) of the membranes was carried out in OH⁻ form using the following equation:

$$WU ( \% ) = \frac{{M}_{w} - {M}_{d}}{{M}_{d}} \times 100 \qquad ( 2 )$$

wherein M_{w} is the mass of the wet membrane and M_{d} is the mass of the dry membrane. The swelling ratio of the membranes was determined in OH⁻ form using a piece of membrane with dry dimensions of 1×3 cm. The length of the membrane was recorded wet and after drying under vacuum at 60° C. for 24 h. The swelling ratio was determined using the following equation:

$$SR ( \% ) = \frac{{L}_{w} - {L}_{d}}{{L}_{d}} \qquad ( 3 )$$

wherein L_{w} is the wet length and L_{d} is the dry length of the membranes. The hydration number (λ) of the membranes was determined using the following equation:

$$λ = \frac{1000 \times WU}{IEC \times 18} \qquad ( 4 )$$

wherein IEC and WU are calculated as above, and 18 is the molecular mass of water.

The in-plane conductivity of the membranes was determined by electrochemical impedance spectroscopy using a potentiostat and a 2-probe conductivity cell. The wet membrane (approx. 1.5×3.0×0.004 cm) in OH⁻ form was quickly loaded into the conductivity cell and placed in a Nalgene bottle containing fresh nitrogen-purged DI water. The impedance was measured from 25-80° C. over a frequency range of 10⁶-1 Hz using a 10 mV AC signal. The resistance of all samples was determined from the high frequency intercept of the real axis, with the conductivity determined using the following equation:

$$σ = \frac{L}{RWt} \qquad ( 5 )$$

wherein L is the length between electrodes (1.65 cm), R is the resistance, W is the membrane width, and t is the membrane thickness. For alkaline stability testing, samples were immersed in a 1 M NaOH solution in a Teflon perfluoroalkoxy bottle and heated at 80° C. for 1000 h. The conductivity of the membranes was measured periodically after thoroughly rinsing with deionized water before being placed back into fresh NaOH solution.

Small angle neutron scattering (SANS) measurements were conducted on the General Purpose SANS (GP-SANS) beamline at the High Flux Isotope Reactor (HFIR), Oak Ridge National Laboratory (ORNL) (W. T. Heller et al., Journal of applied crystallography, 2 (51), 242-248, 2018). The neutron wavelength was λ=4.75 Å with spread Δλ/λ=0.13, and three configurations with sample-to-detector distances of 1, 7, and 19 m were used to cover the scattering wavevector q range from 0.006 to 0.5 Å⁻¹. The scattering wavevector is defined as q=(4π/λ)(sinθ) with 2θ being the scattering angle. The membrane samples were sandwiched by two quartz windows. Wet samples were obtained by soaking the membranes with D₂O. All measurements were conducted at ambient temperature. The 2D scattering data was azimuthally averaged to 1D data before further analysis. The raw intensity data was corrected for transmission, thickness, detector efficiency, the quartz cell background, instrument noise, and converted to absolute units, cm⁻¹ using a secondary standard. (W. T. Heller et al., SoftwareX, (19), 101101, 2022).

### MEA Preparation and Testing for AEMFCs

Two MEAs were prepared to evaluate the performance of the polynorbornene membrane. The first MEA used one of the polynorbornene membranes (QPN). The other MEA used a polyolefinic quaternized polystyrene block copolymer membrane (XL-SEBS) for comparison purposes. A quaternized poly(fluorene) ionomer was used for the catalyst binder (S. Adhikari et al., ACS Appl Energ Mater, 3 (5), 2663-2668, 2022). The preparation of the XL-SEBS membrane and MEA fabrication was described in a previous report (J. Y. Jeon et al., Macromolecules, 5 (52), 2139-2147, 2019). The QPN-based MEA was prepared as follows. Catalyst ink solutions were prepared by combining 20 mg of 75 wt .% metal PtRu/C catalyst for the anode, or 60 wt % Pt/C, with 69.2 mg of 5 wt % poly(fluorene) (F₅N65) ionomer solution and 2 g of 80/20% 2-propanol/Milli-Q water solution. Gas diffusion electrodes (GDEs) were prepared by hand-painting the catalyst ink solution on a 5 cm² gas diffusion layer on a vacuum plate at 60° C. The resulting loading was 0.5 mg_{Pt}/cm² for the anode and 0.6 mg_{Pt}/cm² for the cathode.

The MEAs evaluating ionomer performance were prepared as follows. The catalyst ink solutions were prepared by combining 20 mg of 75 wt. % metal PtRu/C catalyst for the anode, or 60 wt % Pt/C, with 69.2 mg of 5 wt. % FLN-55 or QP-NB ionomer solution and 2 g of 80%/20% 2-propanol/Milli-Q water solution. Gas diffusion electrodes (GDEs) were prepared by hand-painting the catalyst ink solution on 5 cm² gas diffusion layers on a vacuum plate at 60° C. The resulting loading, confirmed by X-ray fluorescence spectroscopy, was 0.5 mg_{Pt} cm² for the anode and 0.6 mg_{Pt} cm⁻² for the cathode. The membrane utilized for ionomer testing was a hexamethyl trimethyl ammonium functionalized Diels-Alder poly(phenylene HTMA-DAPP (25 μm thickness).

AEMFC performance was tested using the prepared MEAs. Prior to assembly into the test cell, the GDEs, and the membrane were soaked in a 1 M NaOH solution for 2 h. The components were then assembled into a 5 cm² single-serpentine test cell with 180 μm reinforced gaskets and torqued to 50 in-lbs. The cell was attached to a test station and brought up to 60° C. without gas flow. Once reaching 60° C., reactant gas flows of 500 sccm H₂ and O₂ were introduced with 100% RH at 147 kPa_{abs} backpressure, and a cell voltage of 0.5 V was applied. Once the cell reached 80° C., the reactant gas flow rates were increased to 1400/700 sccm anode/cathode, and RH remained 100%. The cell was kept at constant voltage until current and high frequency resistance (HFR) stabilized, approximately 2 h. Once stabilized, RH conditions were modified until the optimal performance was obtained.

Following this break-in procedure, the cell was cooled to room temperature, removed from the test station, and flushed with 6 mL of NaOH solution on the anode and cathode. The cell was sealed and allowed to sit overnight at ambient conditions. The cell was again flushed with 3 mL of 1 M NaOH on the anode and cathode, followed by 6 mL of Milli-Q water anode and cathode. The warm-up procedure for the cell was the same as the break-in on the previous day. Once current and HFR stabilized, and optimal RH conditions found, cell performance was determined using polarization curves were obtained at 285 kPa_{abs} backpressure.

### Results and Discussion

### Polymer Synthesis

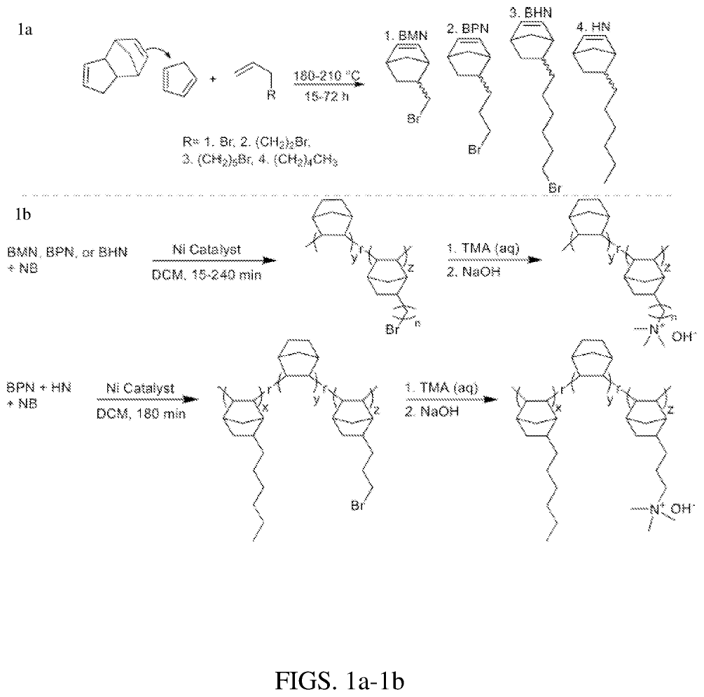

Three brominated monomers were synthesized for this study, with alkyl tether lengths of 1 (BMN), 3 (BPN), and 6 (BHN) carbon atoms (FIG. 1a). In addition, a hydrophobic monomer with an n-hexyl sidechain (HN) was synthesized. All the monomers were synthesized by a high-temperature Diels-Alder reaction between the corresponding vinyl compound and the in-situ formation of cyclopentadiene. The monomers were purified by subsequent distillations, except for the BHN monomer. A mixture of the BHN monomer and unreacted dicyclopentadiene was distilled from the vinyl compound and higher order norbornene derivatives, then separated by column chromatography. The catalyst selected for the polymerizations demonstrates superior functional group tolerance and the ability to yield high molecular weight polymers (K. R. Gmernicki et al., ACS Macro Lett, 7 (5), 879-883, 2016; S. Martinez-Arranz et al., Macromolecules, 18 (43), 7482-7487, 2010). The catalyst, trans-[Ni(C₆F₅)₂(SbPh₃)₂], was synthesized following a published procedure (K. R. Gmernicki et al., ACS Macro Lett, 7 (5), 879-883, 2016).

To fabricate membranes with excellent mechanical robustness, it was found desirable to target polymers with molecular weights of >100 kg/mol. Mₙ of all polymers were >160 kg/mol, above the target value of 100 kg/mol (Table 1) with excellent yields (>95%). Molecular weights are similar to reported values using the trans-[Ni(C₆F₅)₂(SbPh₃)₂] catalyst (M. A. Higgins et al., J Pol Sci, 18 (58), 2644-2653, 2020; S. Martinez-Arranz et al., Macromolecules, 18 (43), 7482-7487, 2010) and higher than polymers synthesized with a palladium-based catalyst system (J. C. Daigle et al., Journal of Polymer Science Part A: Polymer Chemistry, 12 (51), 2669-2676, 2013; E. C. Kim et al., Macromolecules, 14 (54), 6762-6771, 2021; F. Pierre et al., Polymer, (86), 91-97, 2016). Random copolymers were synthesized by utilizing norbornene (NB) and an alkyl bromonorbornene, BMN, BPN, or BHN to form PBMN, PBPN, and PBHN polymers (FIG. 1b). The terpolymers were synthesized using NB, BPN, and HN. The molar ratio of HN was increased from 6 to 30 mol % to determine the impact of increasing hydrophobicity on membrane properties (FIG. 1b) to make polymers PBPN-HN6, PBPN-HN15, and PBPN-HN30, where the number next to HN indicates its mol %. The ratio of each monomer unit incorporated into the polymer was determined by ¹H NMR and the degree of bromine functionality in the copolymer was controlled to achieve polymers with a target quaternized trimethylammonium (OH⁻) IEC of 1.9 meq/g.

A heterogeneous reaction method was utilized for the fabrication of the AEMs. Free-standing membranes were obtained by tape casting the polymers from a 4 wt % chloroform solution onto a glass plate. After drying to remove any residual solvent, membranes were removed from the glass plate and were immersed in a 45 wt % aqueous trimethylamine solution for 48 h at room temperature. The degree of conversion to quaternary ammonium form was confirmed by acid-base titration since it is difficult to utilize NMR due to the limited solubility of the ionic polymers. All membranes had a titrated IEC lower than expected based on theoretical IEC values calculated from the NMR of the brominated precursor (Table 2). The slightly lower titrated IEC than that expected is possibly due to incomplete exchange of the BP counter-ion to OH⁻ form or conversion to trimethylammonium form. The QMN polymer exhibited limited conversion despite extending the reaction time, increasing the temperature (1 week at 80° C.), and the addition of a polar aprotic solvent to the aqueous TMA solution. The poor conversion to quaternary ammonium (<5%) is likely due to steric hindrance of the methyl bromine in membrane form.

TABLE 1
Synthetic details for brominated polynorbornenes
used for the fabrication of AEMs.

| | Reaction | Feed | Polymer | Molecular | |
|---|---|---|---|---|---|
| | Time | Composition | Composition | Weight, | Dispersity |
| Sample | (h) | HN:NB:BXN^{a} | HN:NB:BXN^{b} | Mₙ (kDa)^{c} | (Ð)^{c} |
| PBMN | 3 | 0:74:26 | 0:75:25 | 316 | 1.86 |
| PBPN | 0.25 | 0:76:24 | 0:76:24 | 3961 | 2.83 |
| PBHN | 4 | 0:72:28 | 0:76:24 | 838 | 2.46 |
| PBP-HN6 | 3 | 6:70:24 | 7:69:24 | 483 | 2.94 |
| PBP-HN15 | 3 | 15:60:25 | 14:62:24 | 169 | 2.56 |
| PBP-HN30 | 3 | 30:41:29 | 27:43:30 | 229 | 2.24 |

^{a}Molar ratio of monomers, X refers to alkyl bromonorbornene chain length.
^{b}Molar ratio determined by ¹H NMR spectroscopy.
^{c}Determined by SEC against polystyrene standards with trichlorobenzene as the eluent.

TABLE 2
AEM properties.

| | | | | Water |
|---|---|---|---|---|
| AEM | IEC^{a} | IEC^{titrated} | OH⁻ Conductivity | Uptake |
| Sample | (meq/g) | (meq/g) | (mS/cm), 80° C. | (%) |
| QMN | 2.1 | n/a | n/a | n/a |
| QPN | 2.0 | 1.8 | 109 | 71 |
| QHN | 1.8 | 1.7 | 90 | 91 |
| QP-HN6 | 1.9 | 1.6 | 86 | 62 |
| QP-HN15 | 1.8 | 1.5 | 73 | 56 |
| QP-HN30 | 1.9 | 1.6 | 68 | 55 |

^{a}Theoretical IEC (in TMA OH⁻ form) determined from moles of bromine in polymer by ¹H NMR

### Swelling, Uptake, and Conductivity

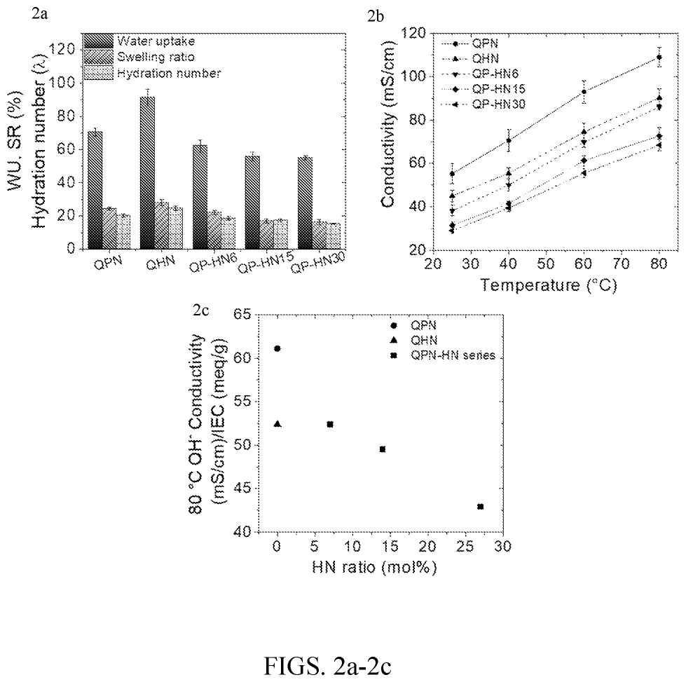

The impact of polynorbornene structure and composition on their membranes' water uptake and swelling ratio were investigated by soaking the membranes in water at room temperature. Water uptake for the AEMs ranges from 91% to 55%. The sample with the longer quaternary ammonium alkyl tether, QHN, exhibits a higher water uptake than that of the QPN membrane (FIG. 2a). The length of the tether is shown to affect water uptake in AEMs. In a previous study, room temperature water uptake increased significantly when the tether length of the quaternary ammonium was greater than 3 carbon atoms (A. M. A. Mahmoud et al., J Mater Chem A, 29 (6), 14400-14409, 2018). The addition of hydrophobic groups decreased water uptake from 71% to 63% for the QPN and QP-HN6 samples, respectively (FIG. 2a). A further reduction in water uptake to 56% was observed for the QP-HN15 sample, although the continued addition of hydrophobic groups (QP-HN30) exhibited little change in water uptake (55%), partially due to the minor differences in IEC values of the membranes. This indicates that molar ratios of ≤15% of HN provide sufficient hydrophobicity to control water uptake. The swelling ratio is related to the stiffness of the polymer backbone and the amount of water uptake. All membrane samples demonstrate a reasonably controlled swelling ratio with the highest occurring for QHN at 28% and the lowest for QP-HN30 at 16% (FIG. 2a). Lambda (λ) is a measure of the number of water molecules per quaternary ammonium group. As expected, λ follows the same trend as water uptake for the membranes, with the highest occurring with the QHN (λ=25) and the lowest in the QP-HN30 sample (λ=15).

The hydroxide conductivity of the membranes was measured in water by electrochemical impedance spectroscopy. The QPN membrane demonstrated the highest hydroxide conductivity. The conductivity of the QPN membrane reached almost 110 mS/cm at 80° C. (FIG. 2b). In comparison, a tetrablock copolymer membrane with a similar IEC and a butyl quaternary ammonium tether length was reported to exhibit a conductivity of approximately 100 mS/cm with a water uptake of 85% (R. Selhorst et al., ACS Appl Energ Mater, 9 (4), 10273-10279, 2021). Interestingly, the QHN membrane showed a lower conductivity but higher water uptake than the QPN membrane. This is counter to the trend where conductivity generally increases with water uptake and is presumably attributed to different hydrated morphologies of the membranes (see SANS discussion below). When a varied ratio of the hydrophobic HN norbornene is incorporated, the conductivity of the AEMs exhibits a decrease in hydroxide conductivity from QP-HN6, to QP-HN15, followed by a slight decrease for QP-HN30, that is directly related to the differences in water uptake. The conductivity of the QP-HN30 terpolymer at 80° C. (68 mS/cm) is similar to the previously reported stat-NMe₃[OH] polynorbornene-based copolymer (61 mS/cm) of similar IEC (1.7 meq/g) and structure (HN and quaternized butylnorbornene) (R. Selhorst et al., ACS Appl Energ Mater, 9 (4), 10273-10279, 2021). When the conductivity of the membranes is normalized to their IEC, a clear trend is observed for the QPN series where the conductivity decreases with continued addition of the HN monomer (FIG. 2c). This demonstrates that a moderate addition of HN is beneficial to reduce water uptake while maintaining reasonable conductivity of the membranes.

### SANS

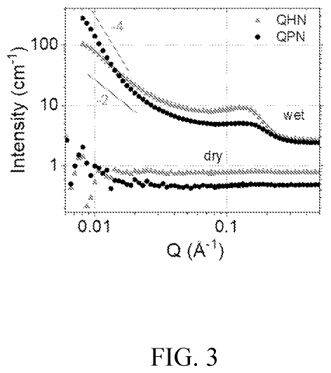

Water uptake can result in changes in the morphology of amphiphilic polymers due to phase separation between the hydrophilic ionic domains and the hydrophobic domains. SANS is a powerful technique to probe the morphologies of membranes due to the contrast between the hydrophilic and hydrophobic domains in membranes if D₂O is used. In this study, SANS measurements were performed on the QHN and QPN membranes in dry and wet states in OH⁻ form to help elucidate the trends observed for ionic conductivity and water uptake. No peaks were observed for these membranes in their dry state (FIG. 3), indicating that they are amorphous and have no phase separation, as expected for a random copolymer. WAXS measurements of the dry membranes show that QHN (d₁=8.86 Å) exhibits a larger interchain distance than QPN (d₁=8.31 Å) likely due to the long alkyl tether (E. C. Kim et al., Macromolecules, 14 (54), 6762-6771, 2021). Upon hydration, both membranes exhibit an ionomer peak in the scattering profile (QHN, Q*=0.13 and QPN, Q*=0.15) corresponding to a domain spacing (d=2π/Q*) of 48 Å for QHN and 42 Å for QPN.

The slope of the low Q upturn region of SANS can provide information on the interface between the hydrophilic and hydrophobic domains (L. Rubatat et al., Macromolecules, 10 (35), 4050-4055, 2002; K. Schmidt-Rohr et al., Materials For Sustainable Energy: A Collection of Peer-Reviewed Research and Review Articles from Nature Publishing Group, 238-246, 2011). The low Q upturn only arises upon hydration for these samples due to phase separation of the hydrophobic backbone and hydrophilic quaternary ammonium groups. The low Q upturn slope is −2 for QHN and −4 for QPN. A slope between −2 and −3 suggests a mass fractal for a network structure that is indicative of poor phase separation, while a slope of −4 indicates phase separation occurs with a sharp interface (Y. Wei et al., J Appl Phys, 17 (129), 171101, 2021). These results indicate that the higher ionic conductivity of the QPN membrane occurs because of better phase separation and well-defined ion transport channels than the QHN membrane.

### Thermal and Mechanical Properties

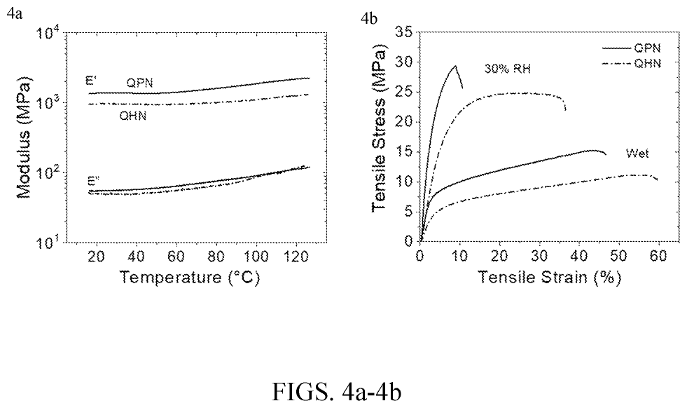

The thermal and mechanical properties of the membranes were evaluated by DMA and tensile measurements. The storage moduli (E′) and loss moduli (E″) were probed under dry conditions (in OH⁻ form) (FIG. 4a). The storage modulus of the QPN and QHN membranes remain above 1 GPa over a wide temperature range. No indication of a thermal transition occurs within the temperature range measured (15-130° C.), as the T_{g} of vinyl-addition polynorbornene copolymers are 160-300° C. or higher, depending on substituents incorporated into the polymer.(E. C. Kim et al., Macromolecules, 14 (54), 6762-6771, 2021; F. Pierre et al., Polymer, (86), 91-97, 2016). The storage modulus of the QHN membrane is lower than that of the QPN membrane, although the loss modulus of the QHN and QPN membranes are comparable. The lower storage modulus of the QHN membrane is likely due to a decrease in rigidity with the long alkyl tether. A similar decrease in E′ was observed for a poly(arylene ether sulfone ketone) with an increase in alkyl chain tether length (R. Akiyama et al., Macromolecules, 9 (51), 3394-3404, 2018).

Stress-strain curves of the membranes were obtained at 30% RH and wet in OH⁻ form. The QPN and QHN membranes demonstrate an excellent maximum tensile stress of ≥25 MPa when dry, with an elongation at 9-38% (FIG. 4b). The cyclic structure of polynorbornenes provides higher tensile strength compared to an elastomeric backbone (e.g., SEBS AEM) and exhibits a lower maximum tensile strength than a rigid aromatic structure (A. D. Mohanty et al., Macromolecules, 19 (48), 7085-7095, 2015; C. Fujimoto et al., J Membrane Sci, (423), 438-449, 2012; W. H. Lee et al., ACS Macro Lett, 8 (4), 814-818, 2015). In the wet state, the membranes become more flexible due to the plasticizing effect of water, with a maximum tensile stress of 10 and 15 MPa and elongation of 60 and 45% for the QHN and QPN membranes, respectively. The greater elongation and lower tensile stress of the QHN membrane is likely due to the higher water uptake of the membrane compared to the QPN membrane, although the influence of molecular weight cannot be ruled out as a contributing factor (H. W. McCormick et al., J Pol Sci, 135 (39), 87-100, 1959). The robust mechanical properties of the membranes in a wet state further confirms their suitability for fuel cell applications. In addition, the high mechanical strength combined with reasonable elasticity permits thin (<15 μm) membranes to be fabricated. A thin membrane is of great importance to reduce the area specific resistance of the membrane and improve water transport across the fuel cell (D. R. Dekel et al., J Power Sources, (420), 118-123, 2019).

TABLE 3
Mechanical properties of QHN and QPN membranes in OH⁻ form.

| | QHN | | QPN | |
|---|---|---|---|---|
| | Max Tensile | Elongation | Max Tensile | Elongation |
| Condition | (MPa) | (%) | (MPa) | (%) |
| 30% RH | 24.8 ± 0.6 | 41.9 ± 4.1 | 25.9 ± 2.8 | 13.8 ± 4.7 |
| Wet | 11.3 ± 2.0 | 59.2 ± 11.9 | 14.9 ± 1.7 | 50.9 ± 5.0 |
| Wet-After | 10.7 ± 0.9 | 31.6 ± 8.4 | 14.1 ± 1.9 | 40.8 ± 8.2 |
| alkaline stability | | | | |

### Alkaline Stability

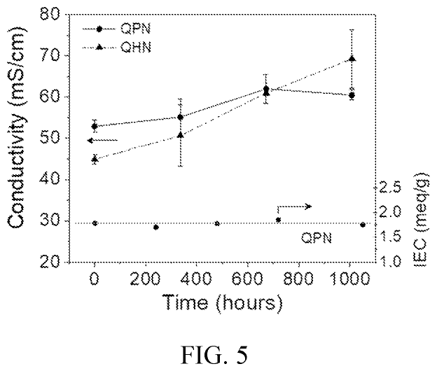

The alkaline stability of the QPN and QHN membranes was evaluated by OH⁻ conductivity (FIG. 5) and tensile measurements (Table 3) after soaking in 1M NaOH for 1000 h at 80° C. The membranes demonstrate no decrease in conductivity after 1000 h of testing and even exhibit an increase in OH⁻ conductivity over time. This increase in conductivity is unusual for AEMs, although it is occasionally observed (R. Akiyama et al., Macromolecules, 5 (52), 2131-2138, 2019; A. M. A. Mahmoud et al., J Mater Chem A, 29 (6), 14400-14409, 2018; S. Maurya et al., J Membrane Sci, (443), 28-35, 2013; K. J. T. Noonan et al., J Am Chem Soc, 44 (134), 18161-18164, 2012). An increase in conductivity with hot acid or water treatment is a well-known effect in PEMs, commonly known as the hygrothermal effect (G. Alberti et al., J Membrane Sci, 1 (185), 73-81, 2001; Y. S. Kim, Dong, L., Hickner, M. A., Pivovar, B. S. and McGrath, J. E., Polymer, 19 (44), 5729-5736, 2003; Y. S. Kim, Wang, F., Hickner, M., McCartney, S., Hong, Y. T., Harrison, W., Zawodzinski, T. A. McGrath, J. E, Journal of Polymer Science Part B: Polymer Physics, 22 (41), 2816-2828, 2003). For example, treatment of sulfonated poly(arylene ether sulfone) with high temperature water increases water uptake and conductivity and causes a morphology change of the membranes.(Y. S. Kim, Dong, L., Hickner, M. A., Pivovar, B. S. and McGrath, J. E., Polymer, 19 (44), 5729-5736, 2003) A similar effect may be occurring with this polymer system, as the water uptake of the membranes increases to 120% for QHN and 85% for QPN after soaking in 1 M NaOH at 80° C. for 1000 h.

Additionally, the IEC of the QPN membrane shows no change over the 1000-h stability test (FIG. 5), another indication that the change in hydroxide conductivity is due to changes in water uptake. Previous studies with polynorbornenes also demonstrate the polymers' excellent alkaline stability, exhibiting a negligible decrease in hydroxide conductivity (approx. 1%) after soaking in 1 M NaOH for 1000 h.(M. Mandal et al., J Electrochem Soc, 5 (167), 054501, 2019; M. Mandal et al., J Membrane Sci, (570), 394-402, 2019, ACS Appl Energ Mater, 4 (2), 2447-2457, 2019). Other highly stable anion exchange polymers include SEBS-TMA and poly(fluorene) (FLN-55), which exhibit <1.5% decrease in IEC during stability testing.(J. Y. Jeon et al., Macromolecules, 5 (52), 2139-2147, 2019; S. Maurya et al., Energ Environ Sci, 11 (11), 3283-3291, 2018). Anion exchange polymers that utilize a 3-6 carbon spacer between the backbone and the quaternary ammonium group often exhibit greater stability in hydroxide solution than those with a single carbon spacer (J. Y. Jeon et al., Macromolecules, 5 (52), 2139-2147, 2019; A. M. A. Mahmoud et al., Macromolecules, 11 (50), 4256-4266, 2017; A. M. A. Mahmoud et al., J Mater Chem A, 29 (6), 14400-14409, 2018; S. Maurya et al., Energ Environ Sci, 11 (11), 3283-3291, 2018; H. Ono et al., J Mater Chem A, 43 (3), 21779-21788, 2015). The stability of the quaternized VAPBNs was further evaluated by tensile measurements after soaking in 1 M NaOH for 1000 h at 80° C. The membranes remain flexible with a similar wet tensile stress as the initial samples (Table 3), indicating that the cyclic aliphatic backbone chemistry of these polynorbornene membranes provides excellent stability in an alkaline environment.

### Fuel Cell Performance

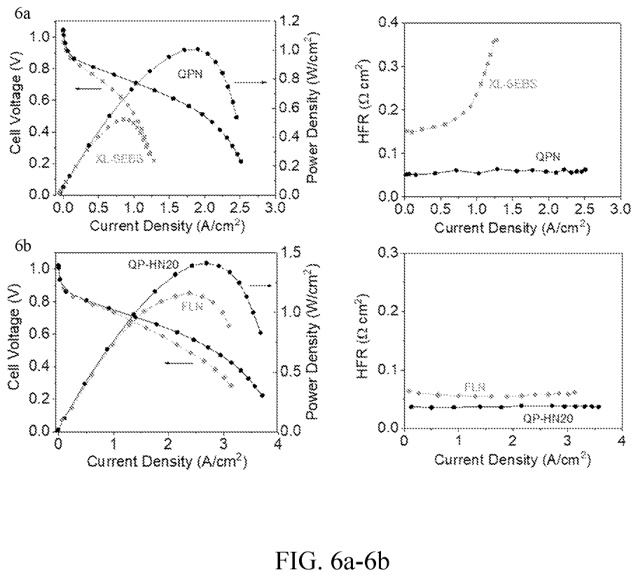

The performance of the quaternized polymers was evaluated in fuel cell devices. The QPN membrane was evaluated in an AEMFC at 80° C. The cell performance was compared with an MEA using a XL-SEBS. Both MEAs used the quaternized poly(fluorene) as the ionomer in both the anode and cathode catalyst layers. SEBS block copolymer membranes have high water uptake (˜150 wt. % at the IEC of 1.6 meq/g); thus, a crosslinked membrane with a crosslinking density of 100% was used. As shown in FIG. 6a, the cell using the QPN membrane showed a superior performance. The substantially higher performance with the QPN cell is probably due to the thin membrane (30 mm for QPN vs. 60 mm thick for XL-SEBS). The high-frequency resistance (HFR) of the QPN cell is only 0.05 W cm², approximately one-third of the XL-SEBS cell HFR. The peak power density achieved with QPN was 1.07 W/cm², comparable to other high performing AEMFC membranes of similar thickness (L. Q. Wang et al., J Mater Chem A, 31 (6), 15404-15412, 2018; A. C. Yang-Neyerlin et al., J Electrochem Soc, 4 (168), 044525, 2021).

Compared to other polyolefinic membranes, the vinyl addition polynorbornene-based materials can be processed as mechanically stable thin membranes because of their high thermal and mechanical stability. In addition, the hydrophobic aliphatic backbone structure combined with a thin membrane makes the polynorbornene-based AEM able to transport water quickly to the cathode side, which makes the HFR stable at high current density, i.e., >1 A cm². Notably, the HFR of the XL-SEBS cell increased to >0.3 Ωcm² at the high current density.

To determine the applicability of quaternized polynorbornene as the ionomer in an AEMFC, a polynorbornene ionomer was also synthesized. From the membrane study above, it was determined that a moderate incorporation of HN reduces water uptake and improves the solubility of the quaternized polymer, while maintaining reasonable conductivity. Thus, a soluble ionomer (QP-HN20, IEC=2.5 meq/g) was designed that achieves a OH⁻ conductivity of 137 mS/cm (80° C. in water) with a water uptake of 95%. FIG. 6b compares the polarization curves of the MEAs using the polynorbornene ionomer and a start of the art poly(fluorene) ionomer (FLN). From the polarization curves it is clear that the polynorbornene-based ionomer, QP-HN20, exhibits superior performance compared to the MEAs using the FLN ionomer. The peak power density of the MEA using the QP-NB ionomer was 1.41 W cm² with low high-frequency resistance (HFR) (0.037 Ωcm²).

### Conclusions

A series of quaternized polynorbornene copolymers were synthesized by vinyl addition polymerization. The quaternary ammonium pendant lengths and ratios of hydrophobic alkyl norbornene moiety were systematically controlled. The present work reveals that a propyl quaternary ammonium tether length (QPN) provides higher conductivity with lower water uptake than a hexyl tether length (QHN). Analysis of the low Q region of SANS indicates that the QPN membrane exhibits more distinct phase separation when wet than the QHN membrane, which promotes higher conductivity. The incorporation of a hydrophobic monomer (HN) decreases the water uptake of the QPN polymer, with a subsequent decrease in hydroxide conductivity. The membranes are mechanically robust with a GPa range storage modulus and a tensile strength of >25 MPa in a dry state and 15 MPa when wet. Furthermore, the membranes are highly stable in an alkaline environment, exhibiting no decrease in IEC and conductivity in 1 M NaOH at 80° C. over 1000 h. The quaternized polynorbornene copolymers were tested in an AEMFC, achieving excellent performance with a peak power density of >1 W/cm². This study provides insight into important design parameters for phenyl-free polynorbornene-based AEMs for use in fuel cell devices.

While there have been shown and described what are at present considered the preferred embodiments of the invention, those skilled in the art may make various changes and modifications which remain within the scope of the invention defined by the appended claims.

What is claimed is:

1. A polymeric composition having the following structure: 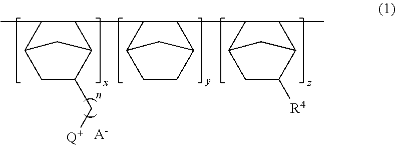
wherein:
Q⁺ is a quaternary ammonium group;
R⁴ is a hydrocarbon group containing 1-12 carbon atoms and optionally substituted by one or more fluorine atoms;
n is an integer of 1-12;
x and y are molar amounts independently selected from 0.01-0.99;
z is 0 or a molar amount selected from 0.01-0.99;
A⁻ is a counteranion;
provided that x+y+z=1.

2. The polymeric composition of claim 1, wherein the polymeric composition is a random copolymer.

3. The polymeric composition of claim 1, wherein the polymeric composition is uncrosslinked.

4. The polymeric composition of claim 1, wherein n is an integer of 1-6.

5. The polymeric composition of claim 1, wherein the polymeric composition has the following structure: 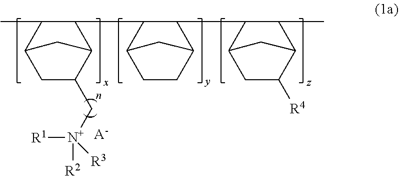
wherein:
R¹, R², and R³ are independently selected from hydrocarbon groups containing 1-6 carbon atoms, wherein R¹ and R² optionally interconnect to form a cyclic nitrogen-containing ring;
R⁴ is a hydrocarbon group containing 1-12 carbon atoms and optionally substituted by one or more fluorine atoms;
n is an integer of 1-12;
x and y are molar amounts independently selected from 0.01-0.99;
z is 0 or a molar amount selected from 0.01-0.99;
A⁻ is a counteranion;
provided that x+y+z=1.

6. The polymeric composition of claim 5, wherein R¹, R², and R³ are independently selected from alkyl groups containing 1-6 carbon atoms.

7. The polymeric composition of claim 1, wherein R⁴ is an alkyl group containing 1-12 carbon atoms and optionally substituted by one or more fluorine atoms.

8. The polymeric composition of claim 1, wherein x and y are molar amounts independently selected from 0.1-0.9; z is 0 or a molar amount selected from 0.1-0.9;
provided that x+y+z=1.

9. The polymeric composition of claim 1, wherein x and y are molar amounts independently selected from 0.2-0.8; z is 0 or a molar amount selected from 0.2-0.8;
provided that x+y+z=1.

10. The polymeric composition of claim 1, wherein x, y, and z are molar amounts independently selected from 0.01-0.99; provided that x+y+z=1.

11. The polymeric composition of claim 1, wherein x, y, and z are molar amounts independently selected from 0.1-0.9; provided that x+y+z=1.

12. The polymeric composition of claim 1, wherein x, y, and z are molar amounts independently selected from 0.2-0.8; provided that x+y+z=1.

13. The polymeric composition of claim 1, wherein y is at least 0.1.

14. An anion exchange membrane fuel cell (AEMFC) comprising:
a) an anode comprising anode particles dispersed in a first binder;
(b) a cathode comprising cathode particles dispersed in a second binder; and
(c) an anion exchange membrane in contact with said anode and cathode;
wherein at least one of said first binder, second binder, and anion exchange membrane has a polymeric composition of the following structure: 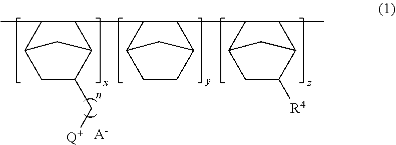
wherein:
Q⁺ is a quaternary ammonium group;
R⁴ is a hydrocarbon group containing 1-12 carbon atoms and optionally substituted by one or more fluorine atoms;
n is an integer of 1-12;
x and y are molar amounts independently selected from 0.01-0.99;
z is 0 or a molar amount selected from 0.01-0.99;
A⁻ is a counteranion;
provided that x+y+z=1.

15. The AEMFC of claim 14, wherein the polymeric composition has the following structure: 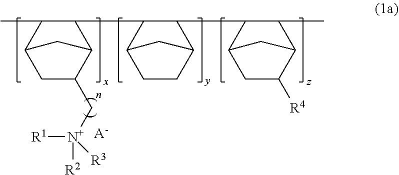
wherein:
R¹, R², and R³ are independently selected from hydrocarbon groups containing 1-6 carbon atoms, wherein R¹ and R² optionally interconnect to form a cyclic nitrogen-containing ring;
R⁴ is a hydrocarbon group containing 1-12 carbon atoms and optionally substituted by one or more fluorine atoms;
n is an integer of 1-12;
x and y are molar amounts independently selected from 0.01-0.99;
z is 0 or a molar amount selected from 0.01-0.99;
A⁻ is a counteranion;
provided that x+y+z=1.

16. The AEMFC of claim 14, wherein the polymeric composition is a random copolymer.

17. The AEMFC of claim 14, wherein the polymeric composition is uncrosslinked.

18. The AEMFC of claim 14, wherein n is an integer of 1-6.

19. The AEMFC of claim 15, wherein R¹, R², and R³ are independently selected from alkyl groups containing 1-6 carbon atoms.

20. The AEMFC of claim 15, wherein R⁴ is an alkyl group containing 1-12 carbon atoms and optionally substituted by one or more fluorine atoms.

21. An anion exchange membrane water electrolyzer (AEMWE) comprising:
a) an anode comprising anode particles dispersed in a first binder;
(b) a cathode comprising cathode particles dispersed in a second binder; and
(c) an anion exchange membrane in contact with said anode and cathode;
wherein at least one of said first binder, second binder, and anion exchange membrane has a polymeric composition of the following structure: 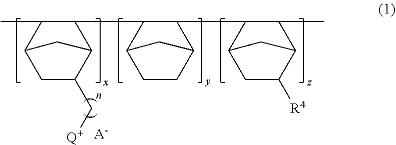
wherein:
Q⁺ is a quaternary ammonium group;
R⁴ is a hydrocarbon group containing 1-12 carbon atoms and optionally substituted by one or more fluorine atoms;
n is an integer of 1-12;
x and y are molar amounts independently selected from 0.01-0.99;
z is 0 or a molar amount selected from 0.01-0.99;
A⁻ is a counteranion;
provided that x+y+z=1.

22. The AEMWE of claim 21, wherein the polymeric composition has the following structure: 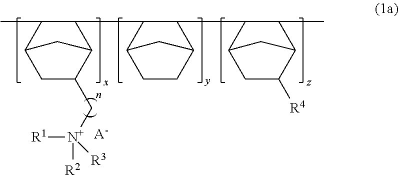
wherein:
R¹, R², and R³ are independently selected from hydrocarbon groups containing 1-6 carbon atoms, wherein R¹ and R² optionally interconnect to form a cyclic nitrogen-containing ring;
R⁴ is a hydrocarbon group containing 1-12 carbon atoms and optionally substituted by one or more fluorine atoms;
n is an integer of 1-12;
x and y are molar amounts independently selected from 0.01-0.99;
z is 0 or a molar amount selected from 0.01-0.99;
A⁻ is a counteranion;
provided that x+y+z=1.

23. The AEMWE of claim 21, wherein the polymeric composition is a random copolymer.

24. The AEMWE of claim 21, wherein the polymeric composition is uncrosslinked.

25. The AEMWE of claim 21, wherein n is an integer of 1-6.

26. The AEMWE of claim 22, wherein R¹, R², and R³ are independently selected from alkyl groups containing 1-6 carbon atoms.

27. The AEMWE of claim 22, wherein R⁴ is an alkyl group containing 1-12 carbon atoms and optionally substituted by one or more fluorine atoms.
